(19) United States
(12) Patent Application Publication
(10) Pub. No.: US 2004/0159197 A1
(43) Pub. Date: Aug. 19, 2004

(54) Apparatus and method for cutting cables and wires

(76) Inventors: Kevin Forsberg, Orlando, FL (US); James Dickens, Ocoee, FL (US); Charles Sawyer, Orlando, FL (US); Isaac D.M. White, Orlando, FL (US); Blake Urban, Lenoir, NC (US)

Correspondence Address: Scott P. Zimmerman, P.O. Box 3822, Cary, NC, 27519, US

(21) Appl. No.: 10/366,031

(22) Filed: Feb. 13, 2003

(51) Int. Cl. B26B 13/00

(52) U.S. Cl. 83/13; 30/90.6; 30/254

(57) ABSTRACT

An apparatus and a method are disclosed for cutting cable. The apparatus has an elongate handle having a first end and a second end, and the first end has a first jaw member. A second jaw member pivots about the handle to form a set of jaws moving between an open position and a closed position. The set of jaws has a first cutting surface opposite a shaped supporting surface that receives and holds the cable being cut. The first cutting surface cuts the cable when the set of jaws is moved to the closed position. A channel in an outer surface of the apparatus includes a second cutting surface protruding from the channel for slitting an outer sheath of the cable. Wherein the cable is laid in the channel and, as the cable is pulled along the channel, the second cutting surface slits the outer sheath of the cable.

### CROSS-REFERENCE TO RELATED APPLICATIONS

This application relates to the co-pending and commonly-assigned U.S. application Ser. No. ______, filed Nov. 30, 2002, entitled “Apparatus and Method for Cutting Cables and Wires,” attorney docket number 02399 (02-BS050), of which the “Brief Summary of the Invention” and the “Detailed Description of the Invention” sections are incorporated herein by reference.

### NOTICE OF COPYRIGHT PROTECTION

A portion of the disclosure of this patent document and its figures contain material subject to copyright protection. The copyright owner has no objection to the facsimile reporduction by anyone of the patent document or the patent disclosure, but the copyright owner otherwise reserves all copyrights whatsoever.

### BACKGROUND OF THE INVENTION

1. Field of the Invention

This invention generally relates to hand tools and, more particularly, to cutlery for cutting strand-encircling sheath.

2. Description of the Related Art

Hand tools have been used to cut electrical wires and cables. These hand tools are often designed to cut coaxial cable, copper conductors, fiber optic cables, and other combinations of cable. Some of these hand tools are designed to strip insulation from the cable and wire, and some of these hand tools are also designed to crimp connectors onto the cut and stripped cable and wire. Although these hand tools have long been used, these prior art hand tools have a common disadvantage. These prior art hand tools do not include features for slicing, or “slitting,” the outer insulation or sheathing of cables and wires. Many connectors and/or terminals must be installed by slicing/slitting the outer insulation/sheathing of a cable or wire. Because these prior art hand tools do not include this feature, technicians resort to knives and blades. These knives and blades, however, are often inefficient. Oftentimes the force applied to the knife or blade is insufficient to cut the sheath, requiring a second cut. Sometimes, however, the force is too great, causing the knife or blade to slice through a portion of the cable and wire. There is, accordingly, a need for a hand tool that includes features for slicing/slitting the outer insulation/sheathing of wires and cables.

### BRIEF SUMMARY OF THE INVENTION

The aforementioned problems, and other problems, are reduced by an apparatus and a method for cutting cable. The term “cable” includes coaxial cable, copper conductors, fiber optic cables, and other conductors for carrying electrical signals. This invention is a hand tool that allows a technician to cut cables and wires. This invention, however, also allows the technician to quickly and to easily slit an outer sheath of the cables and wires. This invention has two cutting surfaces for making two (2) cuts: a first cutting surface for cutting through the cable, while a second cutting surface for slitting the outer sheath of the cable.

An embodiment of this invention describes an apparatus for cutting cable. This apparatus comprises an elongate handle having a first end and a second end. The elongate handle defines a longitudinal axis extending from the first end to the second end. The first end of the handle has a first jaw member. A second jaw member pivots about the handle to form a set of jaws. The first jaw member and the second jaw member are movable about a pivot with respect to each other such that the set of jaws moves between an open position and a closed position. The set of jaws has a first cutting surface and a supporting surface. The supporting surface is opposite the first cutting surface and is shaped to receive and to hold the cable being cut. When the set of jaws is moved to the closed position, the first cutting surface and the opposite supporting surface pivot toward each other and, thus, cut the cable. The apparatus also has a channel in an outer surface of the apparatus, and a second cutting surface is capable of protruding from the channel. The second cutting surface is for slitting an outer sheath of the cable. The cable is laid in the channel and, as the cable is pulled along the channel, the second cutting surface slits the outer sheath of the cable.

Another embodiment of this invention describes a method for cutting cable. The cable to be cut is inserted into a set of jaws. The set of jaws includes a first jaw member, a second jaw member, and a first cutting surface. The set of jaws is formed by the first jaw member pivoting about the second jaw member, and the set of jaws moves between an open position and a closed position. The set of jaws is closed to cause the first cutting surface to cut the cable. The cable is then slid along a second cutting surface protruding from a handle of the set of jaws. The second cutting surface is for slicing an outer sheath of the cable.

### BRIEF DESCRIPTION OF THE SEVERAL VIEWS OF THE DRAWINGS

These and other features, aspects, and advantages of this invention are better understood when the following Detailed Description of the Invention is read with reference to the accompanying drawings, wherein:

FIGS. 1 and 2 are side orthographic views illustrating an apparatus according to this invention;

FIGS. 3-6 are side orthographic views of alternative embodiments of this invention;

FIGS. 7 and 8 are isometric views of still more embodiments of this invention;

FIG. 9 is a schematic illustrating yet another embodiment of this invention;

FIGS. 10 and 11 are side orthographic views illustrating yet another embodiment of this invention;

FIGS. 12 and 13 are side orthographic views illustrating still more embodiments of this invention;

FIGS. 14 and 15 are side orthographic views illustrating even more embodiments of this invention;

FIG. 16 is an exploded, isometric view of another embodiment of this invention; and

FIG. 17 is a flowchart showing a method for cutting a cable.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein; rather, these embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (e.g., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

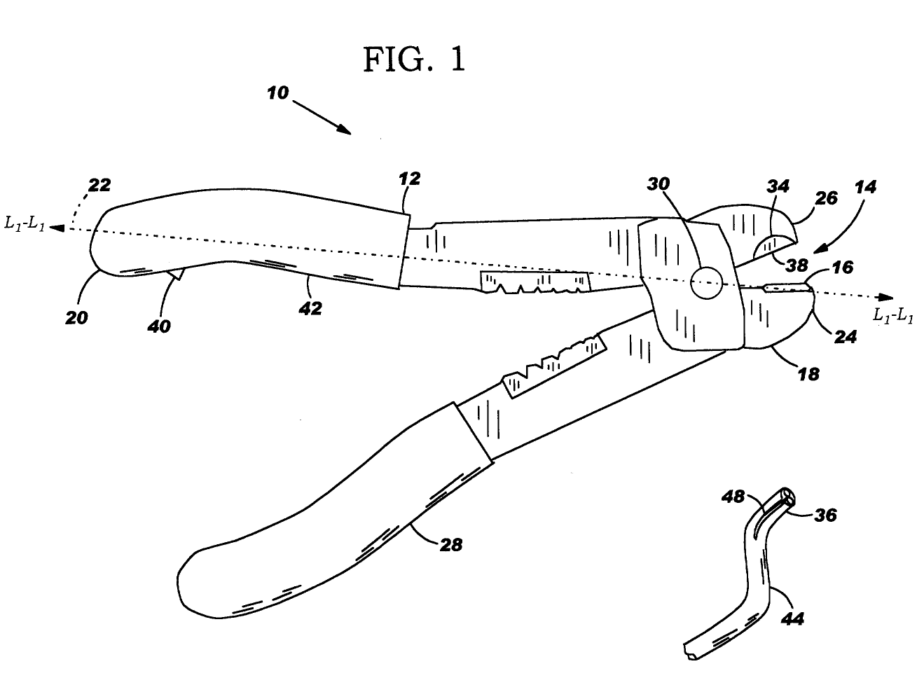

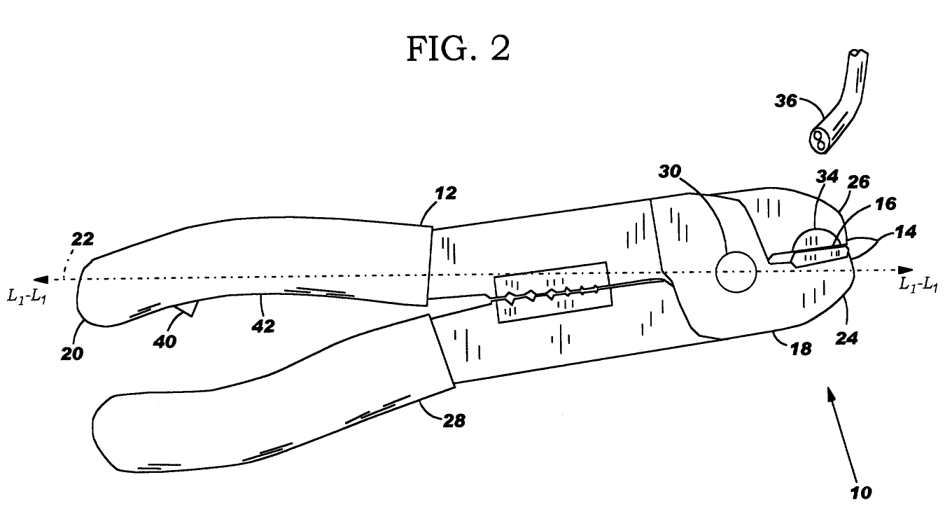

FIGS. 1 and 2 are side orthographic views of an apparatus 10 according to this invention. This apparatus 10 allows a technician to cut cables and wires. This apparatus 10, however, also allows the technician to quickly and to easily slit an outer sheath of the cables and wires. The apparatus 10 comprises an elongate handle 12, a set of jaws 14, and a first cutting surface 16. The elongate handle 12 has a first end 18 and a second end 20. The elongate handle 10 defines a longitudinal axis L₁-L₁ (shown as reference numeral 22) extending from the first end 18 to the second end 20. The set of jaws 14 is formed between a first jaw member 24 and a second jaw member 26. The first jaw member 24 extends from the first end 18 of the handle 12. The second jaw member 26 pivots about the handle 12, and the second jaw member 26 extends from a second handle 28. The first jaw member 24 and the second jaw member 26 are movable about a pivot 30 with respect to each other, such that the set of jaws 14 moves between an open position and a closed position. FIG. 1 shows the set of jaws 14 in the open position, while FIG. 2 shows the set of jaws 14 in the closed position.

The set of jaws 14 also has a supporting surface 34. The supporting surface 34 is opposite the first cutting surface 16. The supporting surface 34 is shaped to receive and to hold the cable 36 being cut. The supporting surface 34, for example, has a cylindrical outer surface 38 that is similar to the cylindrical shape of the cable 36. The supporting surface 34, however, may have other shapes, such as square, oval, or rectangular, to receive and to hold various other shapes of cable. As FIG. 2 best shows, when the set of jaws 14 is moved to the closed position, the first cutting surface 16 and the opposite supporting surface 34 pivot toward each other and, thus, cut the cable 36.

The apparatus 10 also includes a second cutting surface 40. This second cutting surface 40 protrudes from an outer surface 42 of the apparatus 10. The second cutting surface 40 is for slitting an outer sheath 44 of the cable 36. The cable 36 is brought into contact with the second cutting surface 40 and a force is applied. As the cable 36 is pulled along the second cutting surface 40, the second cutting surface 40 cuts a slit 48 in the outer sheath 44 of the cable 36. Because the second cutting surface 40 preferably only slices the outer sheath 44 of the cable 36, the second cutting surface 40 preferably protrudes from the outer surface 42 an amount not exceeding about one eighth of an inch (0.125 inch). Other embodiments, however, may have the second cutting surface 40 protruding more or less than about one eighth of an inch (0.125 inch). The second cutting surface 40 can protrude from any location on the outer surface 42 of the apparatus 10.

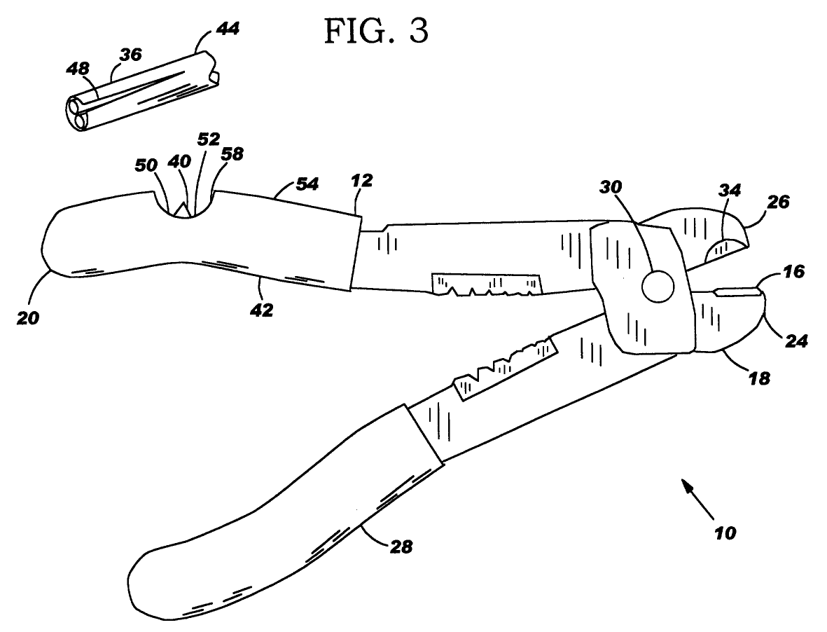

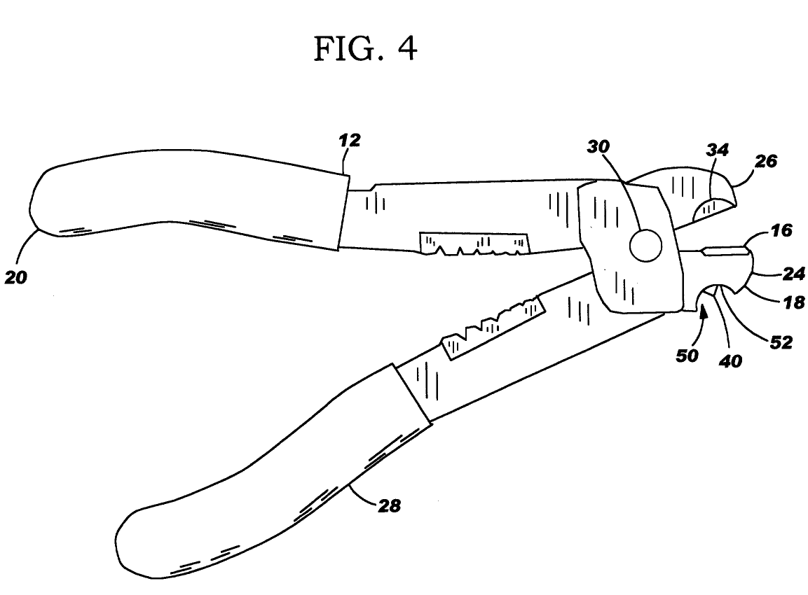

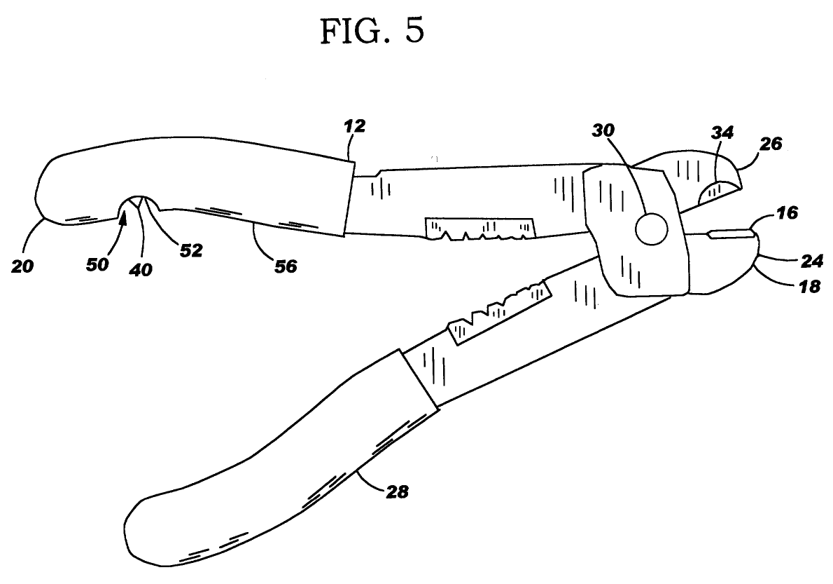

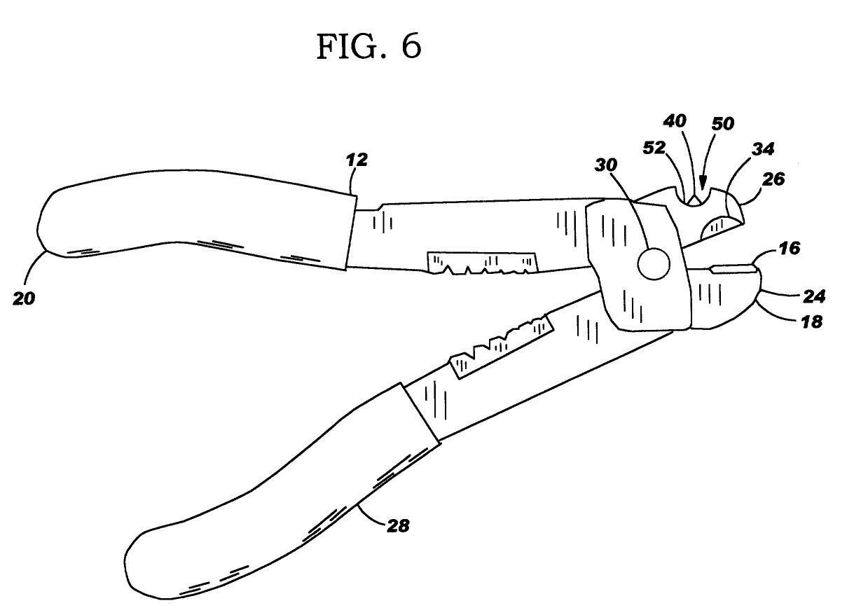

FIGS. 3-6 are side orthographic views of alternative embodiments of this invention. Here the apparatus 10 comprises a channel 50 in the outer surface 42 of the handle 12. The second cutting surface 40 upwardly protrudes from a bottom surface 52 of the channel 50. The second cutting surface 40 is for slitting the outer sheath 44 of the cable 36. FIG. 3 shows the channel 50 proximate an upper surface 54 of the second end 20 of the handle 12. FIG. 4 shows the channel 50 proximate the first end 18 of the handle 12. FIG. 5 shows the channel 50 proximate a lower surface 56 of the second end 20 of the handle 12. FIG. 6 shows the channel 50 proximate the supporting surface 34 opposite the first cutting surface 16. As FIG. 3 best shows, the cable 36 is laid in the channel 50 and a force is applied. As the cable 36 is pulled along the channel 50, the second cutting surface 40 cuts the slit 48 in the outer sheath 44 of the cable 36. The channel 50 is preferably similarly shaped to the cable 36 being slit. The bottom surface 52 of the channel 50, for example, has a cylindrical outer surface 58 that is similar to the cylindrical shape of the cable 36. The bottom surface 52, however, may have other shapes, such as square, oval, or rectangular, to receive and to hold various other shapes of cable.

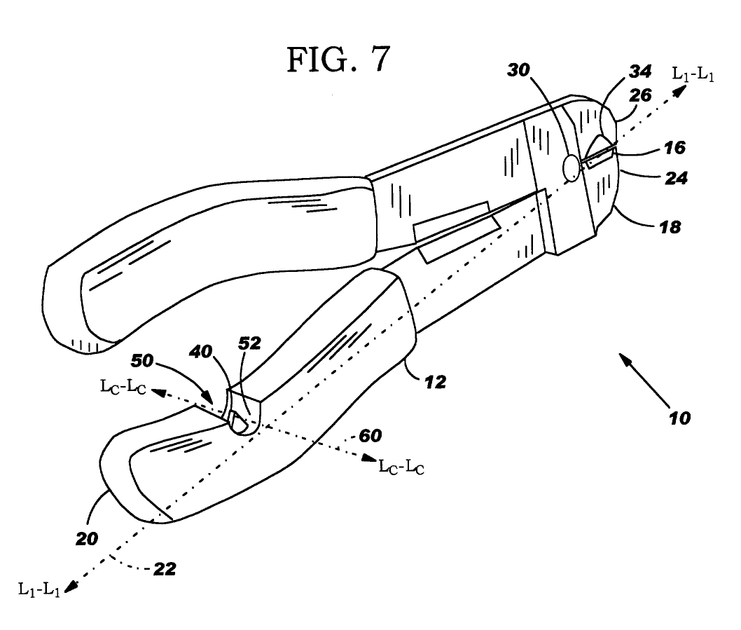

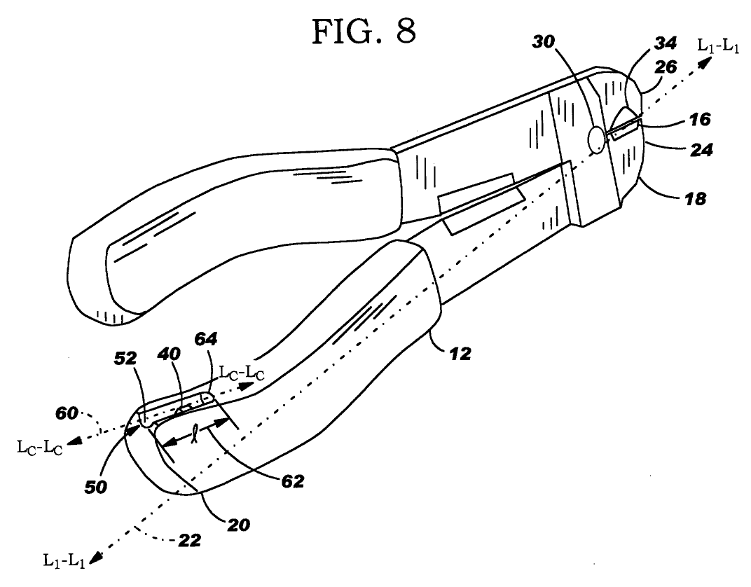

FIGS. 7 and 8 illustrate still more embodiments of this invention. FIGS. 7 and 8 are isometric views of the apparatus 10, and FIGS. 7 and 8 illustrate differing orientations of the channel 50. The bottom surface 52 of the channel 50 defines an axis L_{C}-L_{C} (shown as reference numeral 60) of the channel 50. FIG. 7 shows the channel 50, and thus the axis L_{C}-L_{C}, is substantially perpendicular to the longitudinal axis L₁-L₁ (shown as reference numeral 22) of the handle 12.

FIG. 8, in the other hand, shows a substantially parallel orientation of the channel 50. Here the channel 50 is substantially parallel to the longitudinal axis L₁-L₁ (shown as reference numeral 22) of the handle 12. The channel 50 has a channel length l (shown as reference numeral 62), and the second cutting surface 40 upwardly protrudes from the bottom surface 52 of the channel 50. The channel length l, and the point at which the second cutting surface 40 upwardly protrudes from the bottom surface 52, may be selectively chosen to produce the desired length of the slit in the outer sheath of the cable (shown, respectively, as reference numerals 48, 44, and 36 in FIGS. 1 and 3). If, for example, a one inch (1 in.) slit is desired in the outer sheath, the second cutting surface 40 is placed about one inch (1 in.) from a terminating end 64 of the channel 50. The cable is laid in the channel 50 and a force is applied. As the cable is pulled along the channel 50, the second cutting surface 40 cuts the one-inch slit in the outer sheath. If a two inch (2 in.) slit is instead desired, the second cutting surface 40 is placed about two inches (2 in.) from the terminating end 64 of the channel 50. As long as an end of the cable abuts the terminating end 64 of the channel 50, the length of the slit will be approximately the desired length after the cable is pulled along the channel 50.

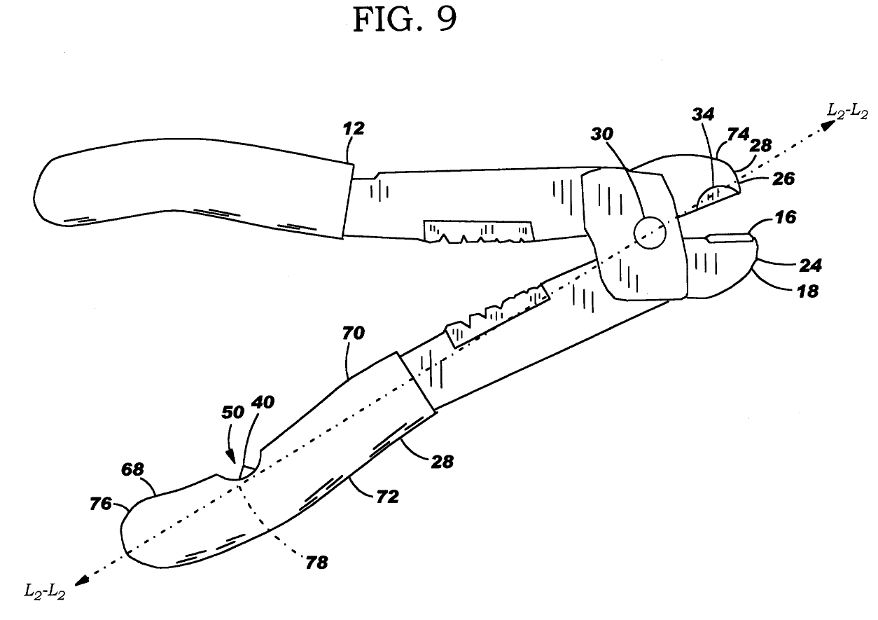

FIG. 9 is a schematic illustrating yet another embodiment of this invention. Whereas FIG. 1-8 showed the second cutting surface 40 protruding from the handle 12, here the second cutting surface 40 protrudes from an outer surface 68 of the second handle 28. Recall that the first jaw member 24 extends from the first end 18 of the handle 12, and the second jaw member 26 extends from the second handle 28. The first jaw member 24 and the second jaw member 26 are movable about the pivot 30 such that the set of jaws 14 moves between the open position and the closed position (shown, respectively, in FIGS. 1 and 2). FIG. 9 illustrates that the second cutting surface 40 and, if included, the channel 50 may alternatively or additionally be formed in the second handle 28. Those of ordinary skill in the art may now recognize that the second cutting surface 40 and, if desired, the corresponding channel 50 may be located proximate an upper surface 70 of the second handle 28 and/or a bottom surface 72 of the second handle 28. The second cutting surface 40 and the corresponding channel 50 may alternatively or additionally be located proximate a first end 74 and/or a second end 76 of the second handle 28. The second cutting surface 40 and the corresponding channel 50, likewise, may be oriented substantially perpendicular to, or substantially parallel to, a longitudinal axis L₂-L₂ (shown as reference numeral 78) of the second handle 28.

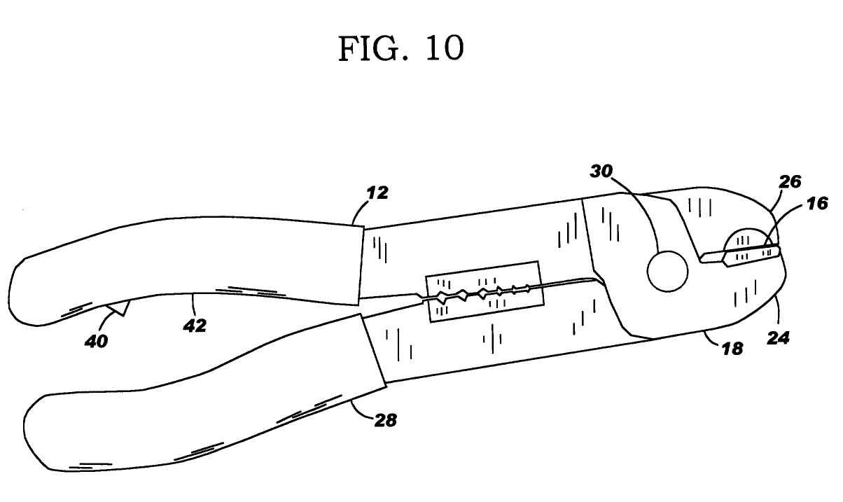

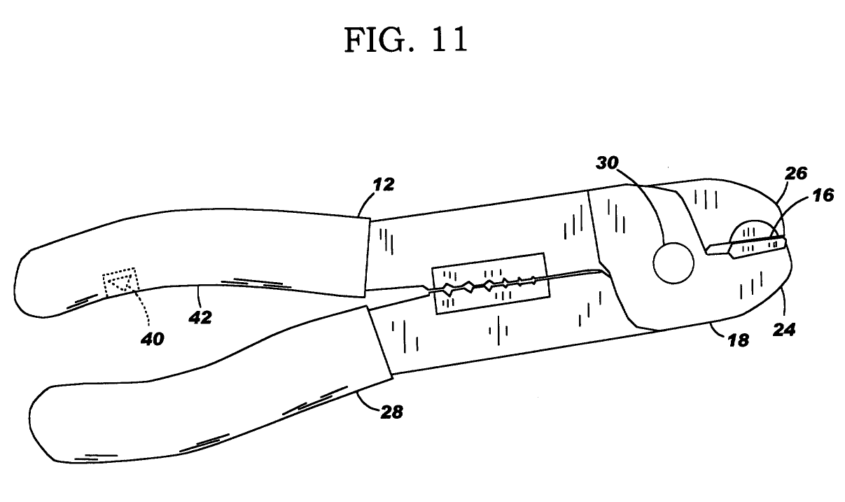

FIGS. 10 and 11 are side orthographic views illustrating yet another embodiment of this invention. Here the second cutting surface 40 extends and retracts from the outer surface 42 of the handle 12. FIG. 10 shows a first position of the second cutting surface 40. This first position has the second cutting surface 40 protruding from the outer surface 42 of the handle 12. Because the second cutting surface 40 preferably only slices the outer sheath of the cable (shown, respectively, as reference numerals 44 and 36 in FIGS. 1 and 3), the second cutting surface 40 protrudes an amount not exceeding about one eighth of an inch (0.125 inch). The second cutting surface 40, additionally, can protrude from any location on the outer surface 42 of the apparatus 10. FIG. 11 shows a second position of the second cutting surface 40. This second position has the second cutting surface 40 retracted within the handle 12.

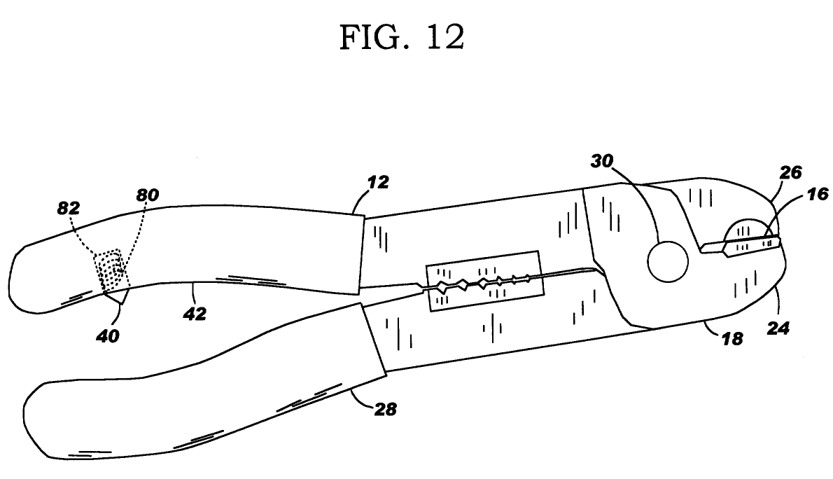

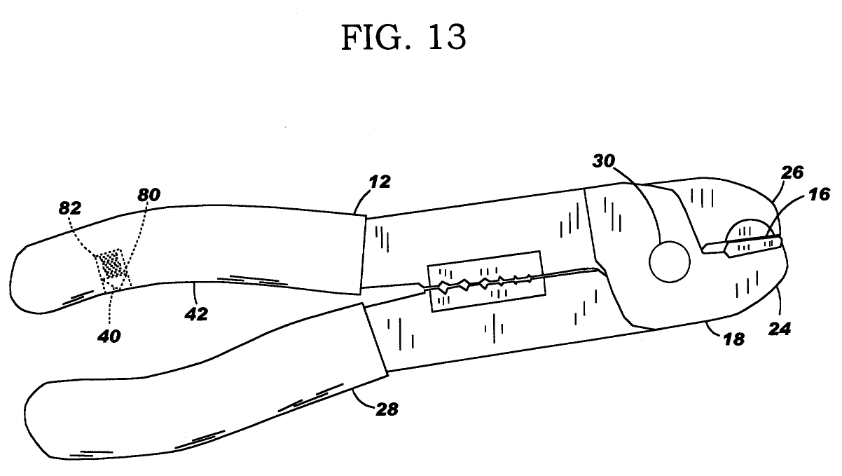

FIGS. 12 and 13 are side orthographic views illustrating still more embodiments of this invention. Here the apparatus 10 comprises means for biasing the second cutting surface 40 between the first position and the second position. FIG. 12, for example, shows a spring 80 biasing the second cutting surface 40 to the first position. This first position has the second cutting surface 40 protruding from the outer surface 42 of the handle 12. The spring 80 exerts a biasing force against a surface 82 to extend the second cutting surface 40. FIG. 13, however, shows the spring 80 in a compressed position. This compressed position allows the second cutting surface 40 to retract within the handle 12.

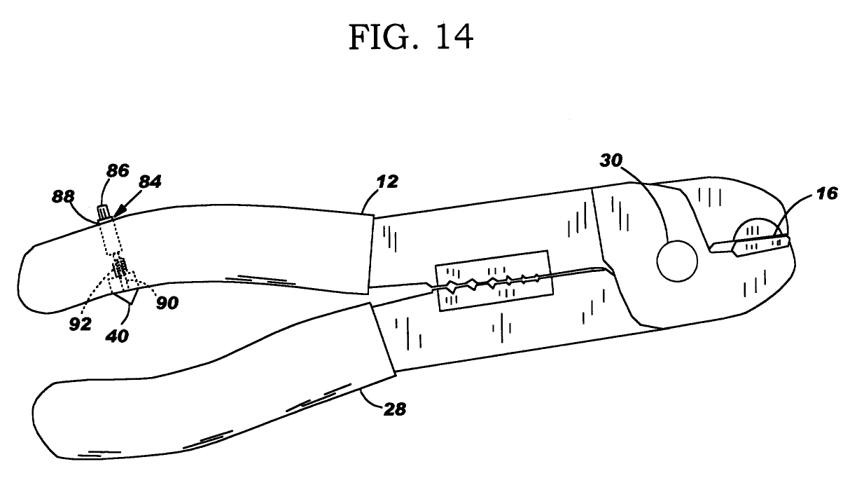

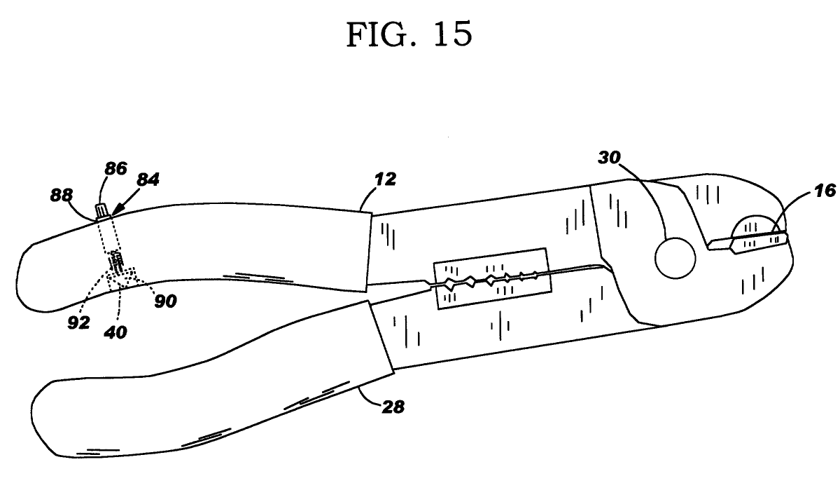

FIGS. 14 and 15 are side orthographic views illustrating even more embodiments of this invention. Here the means for biasing the second cutting surface 40 comprises a so-called “double-clicking mechanism” 84. A push button 86 extends from an aperture 88 in the handle 12. The push button 86 and the second cutting surface 40 are connected by the “double-clicking mechanism”84. This double-clicking mechanism 84 resembles a clicking-type ball point pen assembly. A clicking rod 90 is projected by depression of the push button 86, and the clicking rod 90 is retracted by another depression of the push button 86. A return spring 92 provides a biasing force that urges the clicking rod 90 upward. The double-clicking mechanism 84 is capable of exerting an equal and opposite force to any cutting force. FIG. 14 shows a depression of the push button 86 causes the double-clicking mechanism 84 to extend the second cutting surface 40 to the first position. FIG. 15 shows another depression of the push button 86 causes the double-clicking mechanism 84 to retract the second cutting surface 40 to the second position.

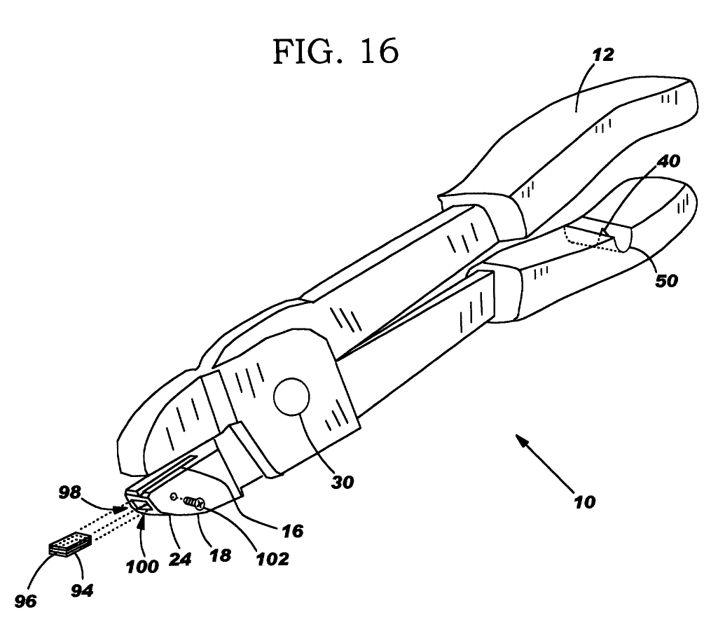

FIG. 16 is an exploded, isometric view of another embodiment of this invention. FIG. 16 shows the apparatus 10 comprising a replaceable cartridge 94. This replaceable cartridge 94 has cutting blades 96 mounted therein. The cutting blades 96 are preferably uniformly-shaped for use as either the first cutting surface 16 and/or the second cutting surface 40. When either the first cutting surface 16 and/or the second cutting surface 40 dulls and needs replacement, either may be removed and replaced with a fresh cutting blade 96 from the cartridge 94. The cartridge 94 inserts into a receptacle 98 in the handle 12. The receptacle 98 is shown as a cavity 100 in the first end 18 of the handle 12. The apparatus 10 may include means for securing the cartridge 94 in the receptacle 98. FIG. 16 shows the means for securing the cartridge 94 comprising a threaded fastener 102. The threaded fastener 102 threads into the first end 18 of the handle 12 and secures the cartridge 94. The means for securing the cartridge 94 could alternatively or additionally comprise a clasp, a tang, a tab, a notch, a latch, a plastic/metal tie, a hook and loop fastener, and/or an adhesive. The means for securing the cartridge 94 could comprise snaps or ridges that secure the cartridge 94 after insertion into the receptacle 98. The means for securing the cartridge 94 could also comprise a frictional engagement between the cartridge 94 and the receptacle 98.

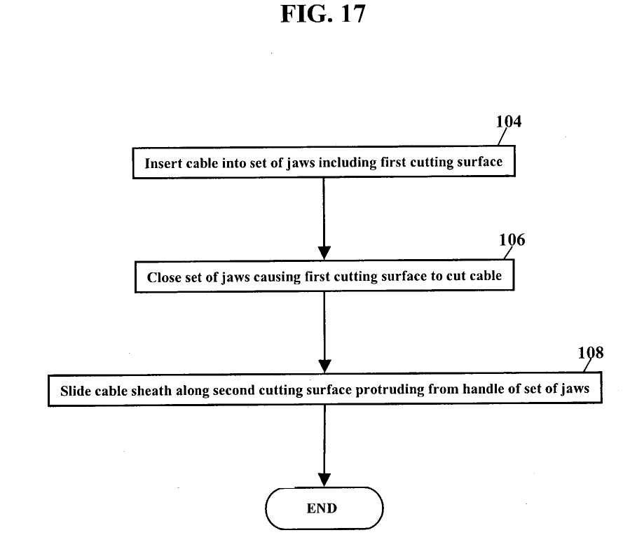

FIG. 17 is a flowchart showing a method for cutting a cable. The cable is inserted into a set of jaws including a first cutting surface (Block 104). The set of jaws is formed by a first jaw member pivoting about a second jaw member, and the set of jaws moves between an open position and a closed position. The set of jaws is closed (Block 106) to cause the first cutting surface to cut the cable. An outer sheath of the cable is positioned over a second cutting surface, and a force is exerted against the cable in a direction towards the second cutting surface. The cable is slid along the second cutting surface protruding from a handle of the set of jaws (Block 108). The second cutting surface slices the outer sheath of the cable.

This invention may also include other features. The apparatus (shown as reference numeral 10 in FIGS. 1-16), for example, may include additional cutting surfaces for cutting and stripping wires. These additional cutting surfaces could resemble a pair of “C”-shaped channels in an outer surface of either handle (shown as reference numerals 12 and 28 in FIGS. 1-16). These “C”-shaped channels align to encircle or “sandwich” the outer insulation or sheathing of a wire in a clam-like fashion. This invention could also include bolt-cutting features, such as a pair of holes that align as the set of jaws (shown as reference numeral 14 in FIGS. 1 and 2) is opened or closed.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. An apparatus for cutting cable, comprising:
an elongate handle having a first end and a second end, the elongate handle defining a longitudinal axis extending from the first end to the second end, the first end of the handle having a first jaw member;
a second jaw member pivoting about the handle to form a set of jaws, the first jaw member and the second jaw member being movable about a pivot with respect to each other such that the set of jaws moves between an open position and a closed position;
the set of jaws having a first cutting surface for cutting the cable when the set of jaws is moved to the closed position; and
a second cutting surface protruding from the handle, the second cutting surface for slitting an outer sheath of the cable,
wherein the cable is pulled along the second cutting surface, and the second cutting surface slits the outer sheath of the cable.

2. An apparatus according to claim 1, further comprising a channel in an outer surface of the handle, the second cutting surface protruding from the channel.

3. An apparatus according to claim 2, wherein the channel is proximate the second end of the handle.

4. An apparatus according to claim 2, wherein the channel is proximate the first end of the handle.

5. An apparatus according to claim 2, wherein the channel is proximate an upper surface of the handle.

6. An apparatus according to claim 2, wherein the channel is proximate a lower surface of the handle.

7. An apparatus according to claim 2, wherein the channel is proximate an outer surface of the handle.

8. An apparatus according to claim 2, wherein the channel is substantially parallel to the longitudinal axis of the handle.

9. An apparatus according to claim 2, wherein the channel is substantially perpendicular to the longitudinal axis of the handle.

10. An apparatus according to claim 1, wherein the second cutting surface protrudes an amount not exceeding about one eighth of an inch (0.125 inch).

11. An apparatus according to claim 1, wherein the second cutting surface has a first position and a second position, the first position having the second cutting surface protrude from the handle, and the second position having the second cutting surface retract within the handle.

12. An apparatus according to claim 11, further comprising means for biasing the second cutting surface between the first position and the second position.

13. An apparatus according to claim 11, further comprising a double-clicking mechanism, the double-clicking mechanism connecting a push button to the second cutting surface, wherein depression of the push button causes the double-clicking mechanism to extend the second cutting surface to the first position, and wherein another depression of the push button causes the double-clicking mechanism to retract the second cutting surface to the second position.

14. An apparatus according to claim 1, wherein the apparatus further comprises a replaceable cartridge, the replaceable cartridge having cutting blades mounted therein.

15. An apparatus according to claim 1, wherein the apparatus further comprises a supporting surface opposite the first cutting surface, the supporting surface being shaped to receive and to hold the cable being cut.

16. A method for cutting a cable, comprising:
inserting the cable into a set of jaws, the set of jaws including a first cutting surface, the set of jaws formed by a first jaw member pivoting about a second jaw member, the set of jaws moving between an open position and a closed position;
closing the set of jaws to cause the first cutting surface to cut the cable; and
sliding the cable along a second cutting surface protruding from a handle of the set of jaws, the second cutting surface slicing an outer sheath of the cable.
